(19) United States
(12) Patent Application Publication
(10) Pub. No.: US 2011/0218735 A1
(43) Pub. Date: Sep. 8, 2011

(54) Real-Time Lithology and Mineralogy Interpretation

(75) Inventors: Xiaogang Han, Tomball, TX (US); Freddy Enrique Mendez, Kingwood, TX (US)

(73) Assignee: Baker Hughes Incorporated, Houston, TX (US)

(21) Appl. No.: 13/031,325

(22) Filed: Feb. 21, 2011

Related U.S. Application Data
(60) Provisional application No. 61/310,809, filed on Mar. 5, 2010.

(51) Int. Cl. G01V 5/04; G06F 19/00

(52) U.S. Cl. 702/8; 702/6

(57) ABSTRACT

Elemental analysis of an earth formation is obtained using measurements from a gamma ray logging tool. From only the elemental analysis and measurements of porosity, density and natural gamma rays, an estimate of the mineralogy of the formation is made treating the problem as one of minimizing a quadratic objective function subject to equality and/or inequality constraints.

### CROSS-REFERENCES TO RELATED APPLICATIONS

This application claims priority from U.S. Provisional Patent Application Ser. No. 61/310,809 filed on Mar. 5, 2010.

### BACKGROUND OF THE DISCLOSURE

1. Field of the Disclosure

The present disclosure is in the field of neutron-induced gamma ray testing of geological formations. In particular, the disclosure determines the mineralogy of a formation from recorded spectra in real time.

2. Description of the Related Art

Well logging systems have been utilized in hydrocarbon exploration for many years. Such systems provide data for use by geologists and petroleum engineers in making many determinations pertinent to hydrocarbon exploration. In particular, these systems provide data for subsurface structural mapping, defining the lithology of subsurface formations, identifying hydrocarbon-productive zones, and interpreting reservoir characteristics and contents. Many types of well logging systems exist which measure different formation parameters such as conductivity, travel time of acoustic waves within the formation, and the like.

One class of systems seeks to measure incidence of nuclear particles on the well logging tool from the formation for purposes well known in the art. These systems take various forms, including those measuring natural gamma rays from the formation. Still other systems measure gamma rays in the formation caused by bursts of neutrons into the formation by a neutron source carried by the tool and pulsed at a preselected interval.

In these nuclear well logging systems, reliance is made upon the physical phenomenon that the energy of gamma rays given off by nuclei resulting from natural radioactive decay or induced nuclear radiation are indicative of the presence of certain elements within the formation. In other words, formation elements will react in predictable ways, for example, when neutrons, either from a pulsed neutron generator or chemical source collide with the nuclei of the formation elements. Different elements in the formation may thus be identified from characteristic gamma rays released as a result of this neutron bombardment. Thus, the number of gamma rays at each energy level will be functionally related to the quantity of each element present in the formation, such as the element carbon, which is present in hydrocarbons. The presence of gamma rays at a 2.2 MeV energy level may, for example, indicate the presence of hydrogen, whereas predominance of gamma rays having energy levels of 4.43 MeV and 6.13 MeV, for example, may indicate the presence of carbon and oxygen, respectively. Furthermore, it should be noted that a variety of neutron emitting sources are known. Examples include americium-beryllium (AmBe) sources, plutonium-beryllium (PuBe) sources, californium sources (e.g., Cf-242) and others. Therefore, while the teachings herein are generally directed to a pulsed neutron source, it should be recognized that the term “neutron emitting” may be considered with reference to the variety of sources now available or subsequently devised.

In these nuclear well logging systems, it is frequently useful to obtain data regarding the energy spectral distributions of the occurrence of the gamma rays. Such data may yield extremely valuable information about the formation, such as identification of lithologies that are potentially-hydrocarbon producing. Moreover, these desired spectral data may not only be limited to that of natural gamma rays, for example, but also may be desired for the gamma ray spectra caused by bombardment of the formation with the aforementioned pulsed neutron sources.

Well logging systems for measuring neutron induced gamma rays in a formation use a pulsed neutron source providing bursts of very fast, high-energy neutrons. Pulsing the neutron source permits the measurement of some earth elements which are difficult measured by using chemical neutron source, like carbon, aluminum. The pulsed neutron source also can provide the measurement of the macroscopic thermal neutron absorption capture cross-section Σ of a formation. The capture cross-section Σ of a reservoir rock is indicative of the porosity, formation water salinity, and the quantity and type of hydrocarbons contained in the pore spaces.

U.S. Pat. No. 7,205,535 to Madigan et al., having the same assignee as the present disclosure and the contents of which are incorporated herein by reference, discloses obtaining an elemental analysis of an earth formation obtained using measurements from a pulsed neutron logging tool. From the elemental analysis, an estimate of the mineralogy of the formation is made treating the problem as one of Linear Programming (maximizing an objective function subject to equality and/or inequality constraints). The linear programming problem is formulated as follows:

Maximize an objective function z:

$$z = {\sum }_{j = 1}^{m} {X}_{j} \qquad ( 1 )$$

subject to a set of n constraints (linear inequalities) of the general form:

$${b}_{i} \geq {\sum }_{j = 1}^{m} {a}_{ij} {X}_{j} , ( i = 1 , n ) \qquad ( 2 )$$

and to a set of m basic constraints (linear inequalities) of the form:

Xⱼ≧0 (j=1,m) (3).

Depending on the material composition of the earth formations proximal to the instrument, the emitted high energy neutrons will mainly undergo neutron inelastic/elastic scattering interaction. The gamma rays resulting from neutron inelastic interactions are used to create “inelastic gamma ray” energy spectra. The scattered neutron will keep scattering and lose its energy until it is “thermalized”. The thermal neutrons may be absorbed, or “captured”, at various rates by certain types of atomic nuclei in the earth formations. When one of these atomic nuclei captures a thermal neutron, the atomic nucleus may emit a gamma ray, which is referred to as a “capture gamma ray”.

A potential disadvantage of the method in Madigan is inherent with maximizing a linear objective function. There is an implicit assumption that there is no error in the measurements. In reality, measurements made by nuclear tools are well known to be affected by statistics, logging speed, and other environmental effects.

There are other prior art methods directed towards determination of mineralogy that allow for uncertainty in the measurements. These prior art methods use, in addition to the results of elemental analysis of a formation using a geochemical tool, measurements from other logs such as density logs, NMR logs, and acoustic logs. The reliance on other logs makes it impossible to obtain a mineralogical analysis in real time.

The present disclosure uses measurements made with logging tools on a single logging string and is thus able to provide an estimate of formation mineralogy in real time. The term “real time” in the context of the present disclosure means “in a matter of seconds” and thus precludes the use of measurements made by logging instruments on an additional logging string.

### SUMMARY OF THE DISCLOSURE

One embodiment of the disclosure is a method of evaluating an earth formation. The method includes: estimating an elemental composition of the earth formation using measurements made by at least one sensor on a downhole assembly conveyed in a borehole in the earth formation; using a processor for estimating, in real-time, a fraction of each of a plurality of mineral constituents that would give the estimated elemental composition; and conducting further operations using the estimated fraction of each of the plurality of mineral constituents.

Another embodiment of the disclosure is an apparatus configured to evaluate an earth formation. The apparatus includes: a downhole assembly configured to be conveyed in a borehole; at least one sensor on the downhole assembly configured to make a measurement indicative of an elemental composition of the earth formation; at least one processor configured to: use the measurement made by the at least one sensor to estimate the elemental composition of the earth formation, use the estimated elemental composition for estimating, in real-time, a fraction of each of a plurality of mineral constituents that would give the estimated elemental composition; and conduct further operations using the estimated fraction of each of the plurality of mineral constituents.

### BRIEF DESCRIPTION OF THE DRAWINGS

The present disclosure is best understood with reference to the accompanying figures in which like numerals refer to like elements and in which:

FIG. 1 illustrates a nuclear well logging configuration according to one embodiment of the present disclosure;

FIG. 2 shows an instrument suitable for use according to one embodiment of the present disclosure;

FIG. 3 shows a string of logging instruments that provide input to a method of analysis according to one embodiment of the present disclosure;

FIG. 4 shows a flow chart of some of the steps of the method according to one embodiment of the present disclosure;

FIG. 5 shows some of the measurements that are input (solid line) to the constrained quadratic optimization of FIG. 4 along with estimated values (dashed lined) after the quadratic programming;

FIG. 6 shows some of the measurements that are input (solid line) to the constrained quadratic programming of FIG. 4 along with estimated values (dashed lined) after the optimization; and

FIG. 7 shows the estimated mineralogy obtained from the quadratic programming module.

### DETAILED DESCRIPTION OF THE DISCLOSURE

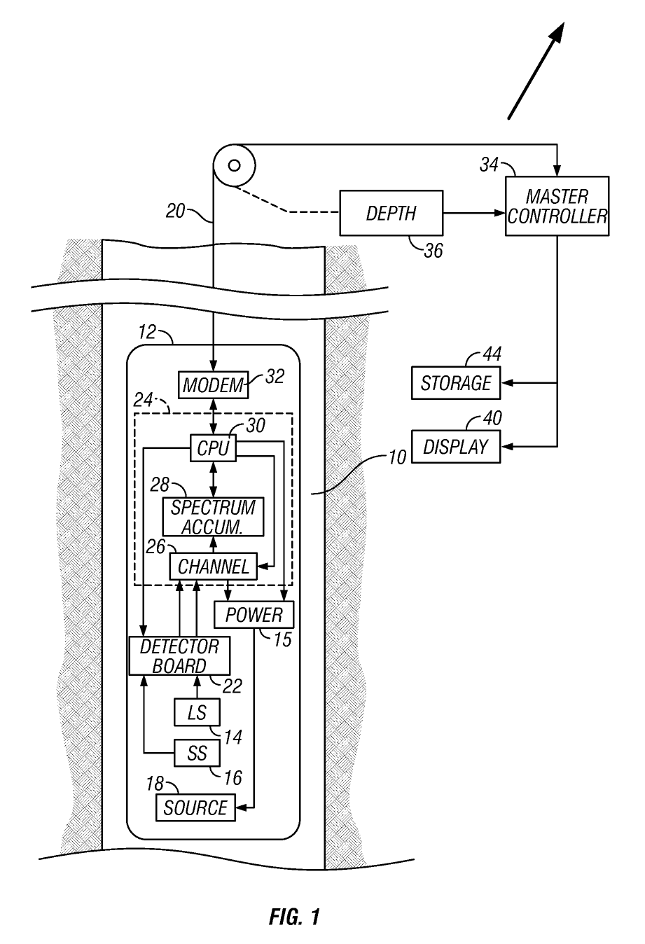

Referring now to the drawings in more detail, and particularly to FIG. 1, there is illustrated a nuclear well logging configuration in accordance with the present disclosure. Well 10 penetrates the earth's surface and may or may not be cased depending upon the particular well being investigated. Disposed within well 10 is subsurface well logging instrument 12. The system diagramed in FIG. 1 is a microprocessor-based nuclear well logging system using multi-channel scale analysis for determining the timing distributions of the detected gamma rays. Well logging instrument 12 includes long-spaced (LS) detector 14, short-spaced (SS) detector 16 and pulsed neutron source 18. In an exemplary embodiment, LS and SS detectors 14 and 16 may be comprised of bismuth-germanate (BGO) crystals coupled to photomultiplier tubes. To protect the detector systems from the high temperatures encountered in boreholes, the detector system may be mounted in a Dewar-type flask. Also, in an exemplary embodiment, source 18 comprises a pulsed neutron source using a D-T reaction, wherein deuterium ions are accelerated into a tritium target, thereby generating neutrons having an energy of approximately 14 MeV. The filament current and accelerator voltage may be supplied to source 18 through power supply 15. Cable 20 suspends instrument 12 in well 10 and contains the required conductors for electrically connecting instrument 12 with the surface apparatus.

The outputs from LS and SS detectors 14 and 16 are coupled to detector board 22, which amplifies these outputs and compares them to an adjustable discriminator level for passage to channel generator 26. Channel generator 26 may convert the output pulse heights to digital values, which are accumulated into pulse height spectra, in which the pulses are sorted according to their amplitudes into a discrete array of bins. The bins uniformly divide the entire amplitude range. These pulse height spectra may be accumulated in registers in the spectrum accumulator 28, the spectra being sorted according to their type: total, capture, or background. After a pulse height spectrum has been accumulated, CPU 30 controls the transfer of the accumulated data to the modem 32, which is coupled to cable 20 for transmission of the data over a communication link to the surface apparatus. To be explained later are further functions of CPU 30 in communicating control commands which define certain operational parameters of instrument 12 including the discriminator levels of detector board 22, and the filament current and accelerator voltage supplied to source 18 by power supply 15.

The surface apparatus may include master controller 34 coupled to cable 20 for recovery of data from instrument 12 and for transmitting command signals to instrument 12. There is also associated with the surface apparatus depth controller 36 which provides signals to master controller 34 indicating the movement of instrument 12 within well 10. An input terminal (not shown) may be coupled to master controller or processor 34 to allow the system operator to provide selected input into master controller 34 for the logging operation to be performed by the system. Display unit 40, and storage unit 44 coupled to the master controller 34 may be provided. The data may also be sent by a link to a remote location. Processing may be done either by the surface processor, at the remote site, or by a downhole processor.

In a well logging operation such as is illustrated by FIG. 1, master controller 34 initially transmits system operation programs and command signals to be implemented by CPU 30, such programs and signals being related to the particular well logging operation. Instrument 12 is then caused to traverse well 10 in a conventional manner, with source 18 being pulsed in response to synchronization signals from channel generator 26. Typically, source 18 is pulsed at a rate of 10,000 bursts/second (10 kHz). This, in turn, causes a burst of high-energy neutrons on the order of 14 MeV to be introduced into the surrounding formation to be investigated. In a manner previously described, this population of high energy neutrons introduced into the formation will cause the generation of gamma rays within the formation, which at various times will impinge on LS and SS detectors 14 and 16. As each gamma ray impinges upon the detectors 14, 16 (typically on a crystal-photomultiplier tube arrangement of the detectors), a voltage pulse having an amplitude functionally related to the energy of the particular gamma ray may be delivered to detector board 22. It will be recalled that detector board 22 amplifies each pulse and compares them to an adjustable discriminator level, typically set at a value corresponding to approximately 100 keV. If such pulse has an amplitude corresponding to an energy of at least approximately 100 keV, the voltage pulse is transformed into a digital signal and passed to channel generator 26 of MCS (Multi-Channel Spectroscopy) section 24.

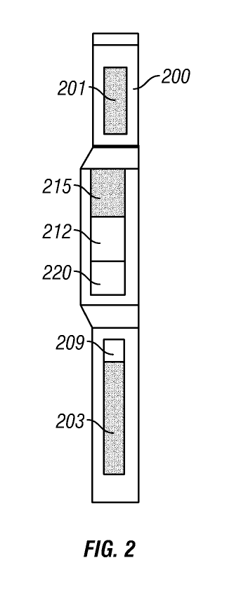

FIG. 2 illustrates a schematic diagram of an instrument suitable for use with the present disclosure. The present disclosure is usable in open-hole wireline logging. Also, under most conditions, measurements may be made in combination with Gamma Ray/Spectralog, Neutron, and Density nuclear tools and or NMR. There are no special storage or transportation requirements except those of a regulatory nature associated with pulsed neutron generators. The logging speed may be dependent upon the environment. A typical logging speed is in the range of 15-30 ft/min.

The measurement device of FIG. 2 employs the principle of neutron-induced gamma ray spectroscopy. The component parts may be encapsulated within wireline device casing 200. The neutron source of the present disclosure is typically a pulsed neutron source. The use of a pulsed neutron source is advantageous over the use of a chemical neutron source due to its ability to operate over a broader range of energies. Neutron source 209 discharges high-energy bursts of neutrons into the surrounding formation. The electronic pulsed neutron generator 209 is typically operated at a rate of approximately 10,000 Hz, so that each burst takes place within a 100 microsecond window. Gamma rays produced via interaction of the discharged neutrons and the formation are detected at the scintillation detector 212 attached to acquisition and telemetry electronics 215. A power supply 201 is provided. Electronics 203 enables the neutron source 209. A neutron shield 220 attenuates the neutron flux propagating directly from the source 209 to the detector 212.

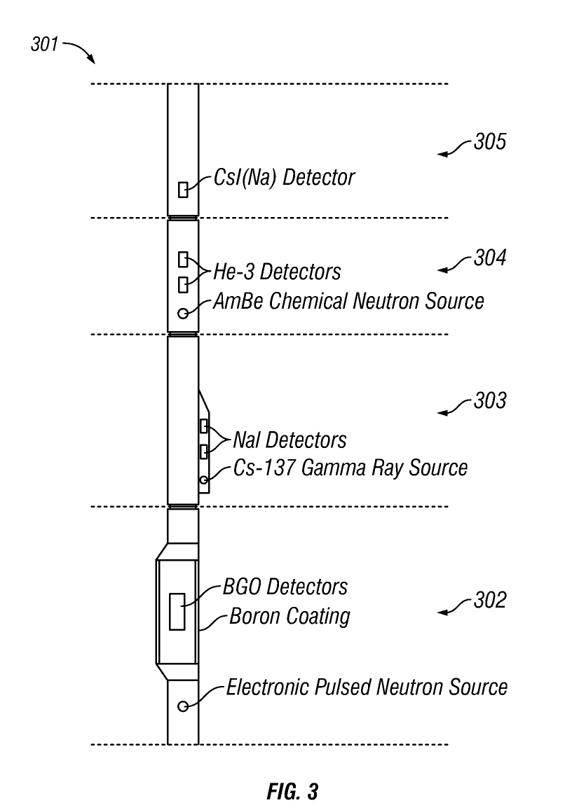

FIG. 3 illustrates exemplary components of a logging string of the present disclosure. The instruments on the logging string 301 may include: a pulsed neutron tool 302 of the kind described above; a density tool 303, a natural gamma ray tool 305; a neutron porosity tool 304; The natural gamma ray tool 305 provides data that is processed to give elemental information on Potassium (K), Thorium (Th) and Uranium (U). The pulsed neutron measurements may be analyzed to give an elemental analysis of other elements using the method discussed in Madigan, wherein an elemental analysis of the pulsed neutron measurements is carried out. The ensemble of tools used may be referred to as a downhole assembly.

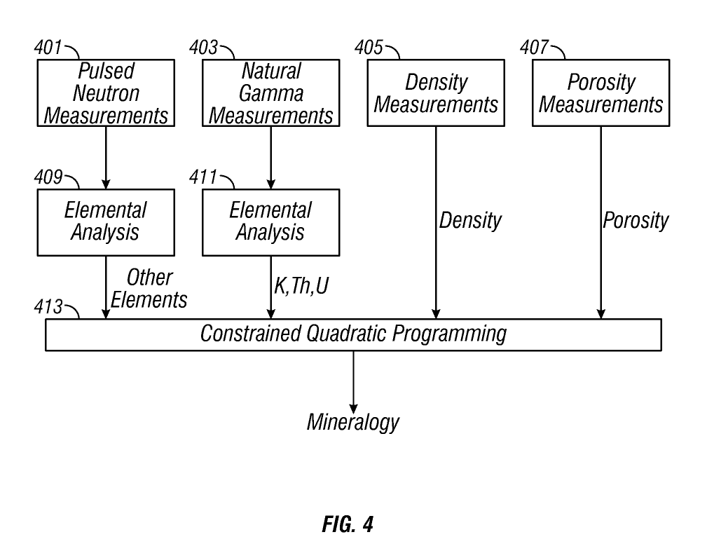

FIG. 4 shows a flow chart of some of the steps of the method of the present disclosure. Natural gamma ray measurements 403 are subjected to an elemental analysis 411 to give an estimate of K, Th, and U. Pulsed neutron measurements 401 are subject to an elemental analysis 409 to give other elements such as Ca, Cl, Fe, Mg, Si, and S. The outputs of the elemental analyses 409, 411, density measurements 405, and porosity measurements 407 are input to a constrained optimization module 413 in a processor. The output of the constrained optimization module is the mineralogy. As in prior art methods, the set of possible minerals in the earth formation is an input to the optimization module 413.

As the name implies, quadratic programming includes a quadratic objective function of the form

$${g}^{T} x + \frac{1}{2} {x}^{T} Hx . \qquad ( 4 )$$

As in prior art methods, other constraints are present. These include:

Bound constraints: bl≦x≦bu (5)

linear constraints: Ax≦b (6), and

non-linear constraints: C(x)≦0 (7).

Here, g is the gradient of ƒ at the current point x, ƒ is the objective function, H is the Hessian matrix (the symmetric matrix of second derivatives). The objective function for this application can be expressed as:

$$f = {\sum }_{i}^{k} \frac{{( {Logdata}_{i} - {f}_{i} ( Component\_volumes ) )}^{2}}{{Var}_{i}} . \qquad ( 8 )$$

The objective function ƒ is minimized at each sample (depth) of the logs independently of the other depths. There are a total of k input logs, denoted by Logdataᵢ. These may include density, porosity, and photoelectric factor (PE) as well as the logs 409, 411 from elemental analysis. The function ƒᵢ relates the mineralogy at each depth to the value of the i-th log. The weighting function Varᵢ gives different weights to the different logs depending upon their accuracy. Generally speaking, density and porosity measurements have the largest weights.

Only measurements such as but not limited to density, neutron porosity, natural gamma ray, and pulsed neutron tools are used in the method. The limitation on the measurements to those on a single logging run makes it possible to estimate the mineralogy in real time. This is in contrast to prior art methods that require the use of measurements made in more than one logging run, thus precluding a real-time estimation of mineralogy.

The allowable minerals include, but are not limited to, quartz, albite, anorthite, microcline, calcite dolomite, siderite, kerogen, pyrite, hematite, anhydrite, glauconitic, chlorite(iron), chlorite, chlorite(mg), kaolinite, smectite, smectite(iron), illite, illite(iron) and fluid. In principle, the other logs and minerals can be added if the tool response is known.

The use of a quadratic objective function in the minimization process means that the log measurements are not treated as absolutely reliable quantities: instead, with a quadratic objective function, the log measurements are not honored precisely and are given a weight according to the variance in the measurements.

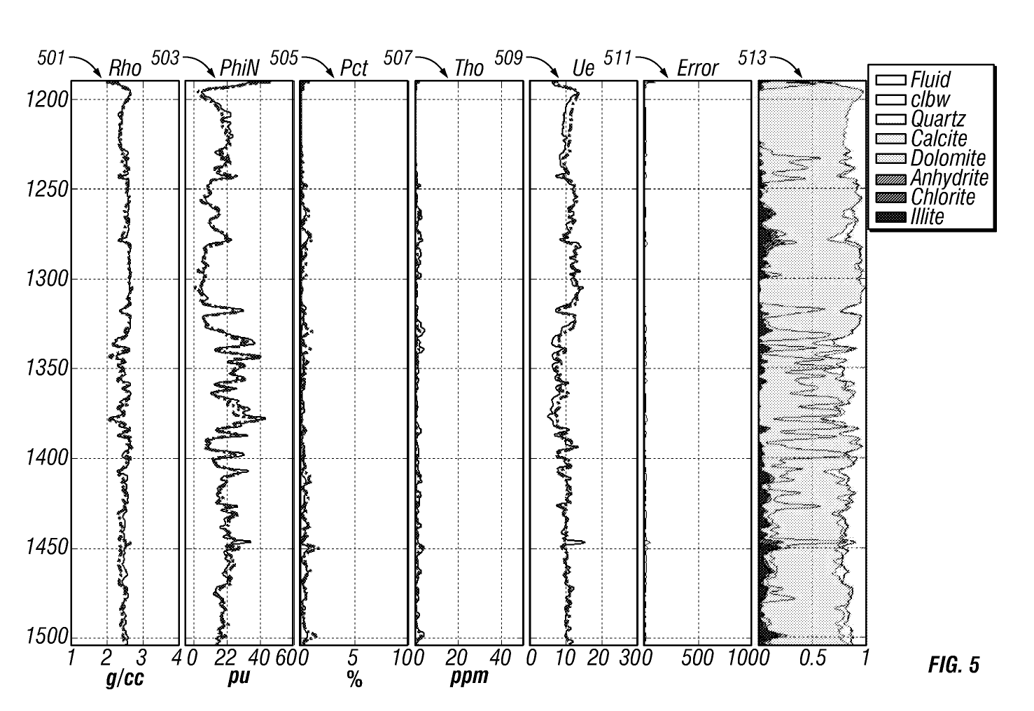

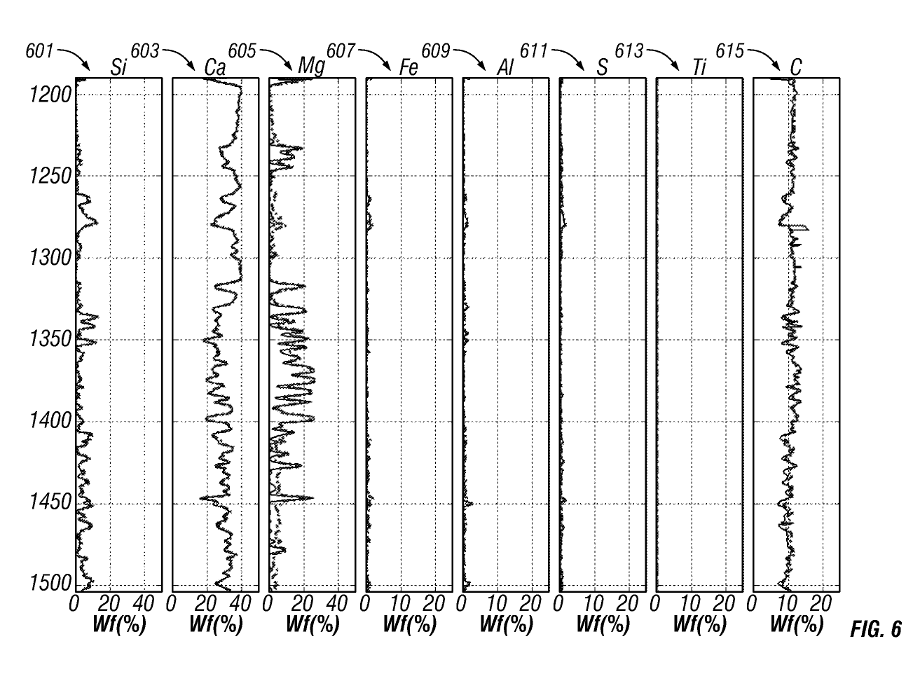

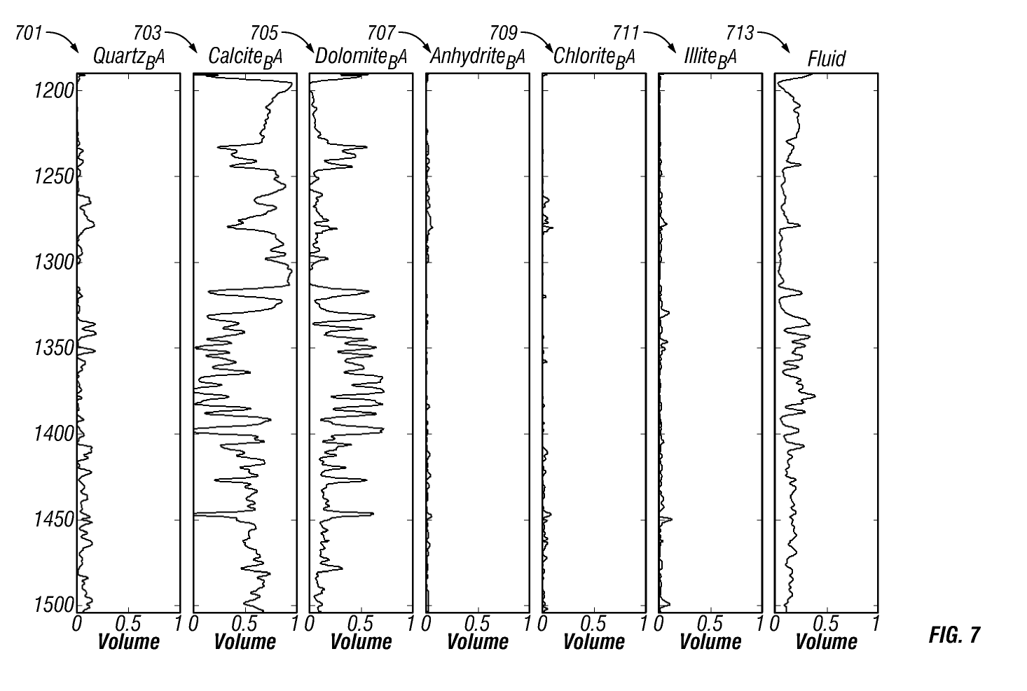

Turning now to FIG. 5, a real log example is shown. The solid line in the panels corresponds to density 501, porosity 503, potassium 505, thorium 507, photoelectric factor 509, and estimated volume of each mineral 513 after processing by the quadratic optimization. The solid lines show in FIG. 6 show additional input measurements and correspond to silicon 601, calcium 603, magnesium 605, iron 607, aluminum 609, sulfur 611, titanium 613 and carbon 615. The resulting data are analyzed according to the quadratic programming method discussed above. The results are shown in FIG. 7 wherein panel 701 shows the estimated volume of quarts, 703 shows the estimated volume of limestone, 705 shows the estimated volume of dolomite, 707 shows the estimated volume of anhydrite, 709 shows the estimated volume of chlorite, 709 shows the estimated volume of illite and 711 shows the estimated volume of pore. each input is assigned with different weight based on the accuracy of measurement. The estimated mineralogy was then used to recomputed what the inputs would be corresponding to the estimated mineralogy and are shown by the dashed lines in FIGS. 5 and 6. The difference between the solid and dashed lines is a result of the quadratic objective function and is included in the fitting error 511.

Once the mineralogy of the earth formation has been estimated in real time, the mineralogy may then be used in guiding the field engineer or geoscientist to make quick decision or further development of a reservoir using known methods. The further development may include selection of intervals in the borehole for perforation and selection of sites for additional wellbores. It is also envisaged that the estimate of mineralogy obtained in real time by the method disclosed above is used for selecting specific intervals for logging with other instruments to provide a more accurate estimate of the mineralogy. Specifically, NMR logging (a time consuming and expensive procedure) may be done, and sidewall coring may be done to provide a calibration of the actual mineralogy.

The disclosure has been described in terms of measurements made using logging tools conveyed on a wireline device in a borehole. The method may also be used using data obtained by sensors conveyed on a slickline. The method may also be used on data obtained using measurement-while-drilling sensors conveyed on a bottomhole assembly by a drilling tubular. For the purposes of the present disclosure, the BHA may be considered to be a downhole assembly.

While the foregoing disclosure is directed to the specific embodiments of the disclosure, various modifications will be apparent to those skilled in the art. It is intended that all such variations within the scope and spirit of the appended claims be embraced by the foregoing disclosure.

What is claimed is:

1. A method of evaluating an earth formation, the method comprising:
making measurements using at least one sensor on a downhole assembly conveyed in a borehole in the earth formation;
using a processor for:
estimating, in real time, an elemental composition of the earth formation from the measurements made by the at least one sensor;
estimating, in real time, a fraction of each of a plurality of mineral constituents that would give the estimated elemental composition; and
conducting further operations using the estimated fraction of each of the plurality of mineral constituents.

2. The method of claim 1 wherein estimating the fraction of each of the mineral constituents further comprises solving a constrained optimization problem including a quadratic objective function.

3. The method of claim 1 further comprising:
making additional measurements indicative of a porosity of the earth formation and a density of the earth formation; and
using the additional measurements for estimating the fraction of each of the plurality of mineral constituents.

4. The method of claim 3 further comprising conveying the downhole assembly into the borehole on a wireline.

5. The method of claim 3 further comprising using only the measurements and the additional measurements for estimating the fraction of each of the plurality of mineral constituents.

6. The method of claim 1 wherein estimating said elemental composition further comprises determining (i) a capture spectrum of gamma rays, and, (ii) an inelastic spectrum of gamma rays.

7. An apparatus configured to evaluate an earth formation, the apparatus comprising:
a downhole assembly configured to be conveyed in a borehole;
at least one sensor on the downhole assembly configured to make a measurement indicative of an elemental composition of the earth formation;
at least one processor configured to:
use the measurement made by the at least one sensor to estimate, in real time, the elemental composition of the earth formation,
use the estimated elemental composition to estimate, in real-time, a fraction of each of a plurality of mineral constituents that would give the estimated elemental composition; and
conduct further operations using the estimated fraction of each of the plurality of mineral constituents.

8. The apparatus of claim 7 wherein the at least one processor is configured to estimate the fraction of the plurality of each of the mineral constituent further comprises solving a constrained optimization problem further including a quadratic objective function.

9. The apparatus of claim 7 wherein the at least one sensor is configured to make additional measurements indicative of a porosity of the earth formation and a density of the earth formation; and wherein the at least one processor is configured to use the additional measurements to estimate the fraction of each of the plurality of mineral constituents.

10. The apparatus of claim 9 further comprising a conveyance device selected from: (i) a wireline, and (ii) a drilling tubular, configured to convey the downhole assembly into the borehole.

11. The apparatus of claim 9 wherein the at least one processor is further configured to use only the measurements and the additional measurements for estimating the fraction of each of the mineral constituents.

12. The apparatus of claim 7 wherein the at least one processor is further configured to estimate the elemental composition using (i) a capture spectrum of gamma rays, and, (ii) an inelastic spectrum of gamma rays.
